(19) United States
(12) Patent Application Publication
(10) Pub. No.: US 2024/0359128 A1
(43) Pub. Date: Oct. 31, 2024

(54) OXYGEN ABSORBING QUILT AND METHOD OF MANUFACTURING THEREOF

(71) Applicant: DESICCARE, INC., Las Vegas, NV (US)

(72) Inventors: Sammie Joe Glorioso, Ridgeland, MS (US); Michael Christopher McClure, Madison, MS (US)

(21) Appl. No.: 18/571,712

(22) PCT Filed: Jun. 16, 2022
(86) PCT No.: PCT/US2022/033883

§ 371 Date: Dec. 18, 2023

Related U.S. Application Data
(60) Provisional application No. 63/212,555, filed on Jun. 18, 2021.

(51) Int. Cl. B01D 53/04; A23L 3/3436; B01J 20/20; B01J 20/28

(52) U.S. Cl. CPC B01D 53/0407; B01J 20/20; B01J 20/2805; A23L 3/3436; B01D 2253/102; B01D 2253/11; B01D 2253/1122; B01D 2253/304; B01D 2257/104; B01D 2259/4525

(57) ABSTRACT

A method for manufacturing an oxygen absorbing quilt including placing a first sheet on one or more heat elements, wherein the heat elements are included on a bottom portion of a sealing machine; placing one or more oxygen absorbing elements on the first sheet; placing a second sheet over the oxygen absorbing elements and the first sheet, wherein the oxygen absorbing elements are positioned between the first and second sheets; moving a top portion of the sealing machine to a sealing position to press the first and second sheets against the bottom portion; increasing, by one or more heat elements, a temperature of the first and second sheets for a sealing time period to form one or more seals between the first and second sheets; decreasing the temperature of the one or more heat elements; and waiting for a cooling time period.

### CROSS-REFERENCE TO RELATED APPLICATION(S)

This application claims priority to, and the benefit of, U.S. Provisional Patent Application Ser. No. 63/212,555, filed on Jun. 18, 2021, entitled OXYGEN ABSORBING QUILT AND METHOD OF MANUFACTURING THEREOF, the entire content of which is incorporated herein.

### BACKGROUND

### 1. Field

The present disclosure relates generally to the field of oxygen control. The present disclosure also relates generally to the field of creating an oxygen absorbing quilt.

### 2. Description of the Related Art

Oxygen control products in general are well known. The control of oxygen in an environment may be desirable for various products, such as food and pharmaceuticals, in order to improve the shelf-life of the product, prevent growth of aerobic microorganisms, and prevent pharmaceuticals from being affected by moisture. Oxygen control products are also used in the medical industry, for example, for blood storage (e.g., for blood transfusions). In particular, anaerobic storage (e.g., storage free from oxygen) can enhance the metabolic status of red blood cells.

Typical oxygen absorbers (or oxygen scavengers) use oxidation of iron or a similar metal to reduce oxygen in an environment, and require water to activate. Additionally, typical oxygen absorbers may be contained in packages such as sachets. However, common oxygen absorbers, such as those that use vermiculite as a carrier, may lose water through evaporation over time. This loss of water may lead to loss of oxygen absorbing functionality. Further, the need to include vermiculite in addition to the oxygen absorbing elements means larger oxygen absorbing sachets are required to package the vermiculite together with the oxygen absorbing elements.

New oxygen absorbing compounds and packaging that require less space can allow for more efficient uses of resources such as storage space, transportation, packaging material, and manufacturing space and also improve the overall performance of oxygen control products.

### SUMMARY

Aspects of embodiments of the present disclosure are directed toward an oxygen absorbing element and method of manufacturing an oxygen absorbing quilt.

Some example embodiments of the present disclosure may provide a method for manufacturing an oxygen absorbing quilt including placing a first sheet on one or more heat elements, wherein the heat elements are included on a bottom portion of a sealing machine; placing one or more oxygen absorbing elements on the first sheet; placing a second sheet over the oxygen absorbing elements and the first sheet, wherein the oxygen absorbing elements are positioned between the first and second sheets; moving a top portion of the sealing machine to a sealing position to press the first and second sheets against the bottom portion; increasing, by one or more heat elements, a temperature of the first and second sheets for a sealing time period to form one or more seals between the first and second sheets; decreasing the temperature of the one or more heat elements; and waiting for a cooling time period before removing the oxygen absorbing quilt from the sealing machine, wherein the one or more seals stabilize during the cooling time period.

According to some example embodiments, the first and second sheets are permeable to gas and resistant to liquid.

According to some example embodiments, adhesive on the first and second sheets form the one or more seals.

According to some example embodiments, the first and second sheets are about equal in size.

According to some example embodiments, the one or more oxygen absorbing elements include a mixture of iron, carbon, diatomaceous earth, salt and water.

According to some example embodiments, the one or more oxygen absorbing elements include one or more packages containing an oxygen-absorbing mixture.

According to some example embodiments, a positioning guide is used to position the one or more oxygen absorbing elements on the first sheet.

According to some example embodiments, the one or more seals form one or more enclosures and the one or more oxygen absorbing elements are contained in the one or more enclosures.

According to some example embodiments, the one or more enclosures are arranged into three rows, wherein each row includes three of the enclosures.

Some example embodiments of the present disclosure may provide an oxygen absorbing element including a sealed sachet containing an oxygen absorbing composition, wherein the oxygen absorbing composition includes iron, carbon, and diatomaceous earth.

According to some example embodiments, the oxygen absorbing element is stored in a nitrogen atmosphere before use.

According to some example embodiments, about 11 grams of the oxygen absorbing composition is capable of removing about 1200 cubic centimeters in volume of oxygen over a time period of about 24 to about 48 hours.

According to some example embodiments, the oxygen absorbing composition further includes salt and water.

According to some example embodiments, the pH of the water is about 7.

According to some example embodiments, water is about 23% by weight of the mixture before salt and water is added.

According to some example embodiments, salt is about 4% by weight of the mixture before salt and water is added.

According to some example embodiments, carbon is 325 mesh carbon.

According to some example embodiments, iron is 325 mesh iron.

According to some example embodiments, the oxygen absorbing composition is made up of about 40-70 wt % iron, about 10-25 wt % diatomaceous earth, and about 10-40 wt % carbon.

According to some example embodiments, the oxygen absorbing composition is made up of about 56.13 wt % iron, about 17.6 wt % diatomaceous earth, and about 26.27 wt % carbon.

### BRIEF DESCRIPTION OF THE DRAWINGS

These and other features and aspects of embodiments of the present disclosure will be better understood by reference to the following detailed description, when considered in conjunction with the accompanying drawings. The same numbers are used throughout the figures to reference like features and components. The figures are schematic in nature and may not be drawn to scale.

FIG. 1 shows a quilt, in accordance with example embodiments of the disclosure.

FIG. 2 shows a sealing machine that may be used in the process for fabricating the quilt, in accordance with example embodiments of the disclosure.

FIG. 3 shows a diagram of a configuration of the heat elements on the base of the sealing machine, in accordance with example embodiments of the disclosure.

FIG. 4 shows a diagram of a configuration of the sealing elements on the sealing part of the sealing machine, in accordance with example embodiments of the disclosure.

FIGS. 5A-5F shows illustrations of the steps for fabricating the quilt using a sealing machine, in accordance with example embodiments of the disclosure.

FIG. 6 shows a diagram of a positioning guide that may be used in the process for fabricating the quilt described above, in accordance with example embodiments of the disclosure.

FIG. 7 is a flowchart showing a method for manufacturing the quilt using a sealing machine, in accordance with example embodiments of the disclosure.

### DETAILED DESCRIPTION

Features of the inventive concept and methods of accomplishing the same may be understood more readily by reference to the following detailed description of embodiments and the accompanying drawings. Hereinafter, embodiments will be described in more detail with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. Further, parts not related to the description of the embodiments might not be shown to make the description clear. In the drawings, the relative sizes of elements, layers, and regions may be exaggerated for clarity.

In the following description, for the purposes of explanation, numerous specific details are set forth to provide a thorough understanding of various embodiments. It is apparent, however, that various embodiments may be practiced without these specific details or with one or more equivalent arrangements.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated about 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

When a certain embodiment may be implemented differently, a specific process order may be performed differently from the described order. For example, two consecutively described processes may be performed substantially at the same time or performed in an order opposite to the described order.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments of the present disclosure are described below.

The present disclosure is directed to various embodiments of a quilt containing one or more enclosures, where each enclosure contains oxygen absorbing elements. The quilt can be fabricated by placing oxygen absorbing elements between two pieces of material and sealing the two pieces of material together. The material may be composed of any suitable material that is resistant to water and permeable to air (e.g., Tyvek). All components of the quilt, including the two pieces of material, may be approved by a medical authority, like the United States Food and Drug Administration (FDA). The two pieces of material may be coated with an adhesive coating that is permeable to air (e.g., oxygen).

According to various embodiments, the oxygen absorbing elements may include a mixture of iron (Fe), carbon (C), diatomaceous earth, salt, and water.

The composition of the mixture differs from typical oxygen absorbing compositions (e.g., those that include vermiculite), and can allow for smaller sachets and require less storage space.

According to various embodiments, the quilt may be manufactured using a sealing machine (e.g., a machine used for heat sealing packaging).

In some embodiments, the sealing machine includes heat elements and heat resistant elements. The heat resistant elements may be composed of Teflon or other suitable heat resistant material. The heat elements can emit heat to increase the temperature of the adhesive on the material used to make the quilt. The heat resistant elements can be used to press the quilt material against the heat elements to create seals and bond two pieces of material together where the adhesive is heated.

The heat and heat resistant elements may be arranged in various configurations (e.g., a grid pattern) according to the desired configuration of the seals. For example, if the seals need to form a grid pattern, then the heat and heat resistant elements would also be configured into a grid pattern. For example, the heat and heat resistant elements may be in a grid configuration that corresponds to a quilt that has nine enclosures that are arranged into a three by three grid.

In some embodiments, a positioning guide may be used to position the oxygen absorbing elements before the oxygen absorbing elements are sealed into the quilt.

The quilt product may be used for storage with various products that are sensitive to oxygen in the surrounding environment. For example, the quilt product may be used for anaerobic storage of blood that is used in blood transfusions.

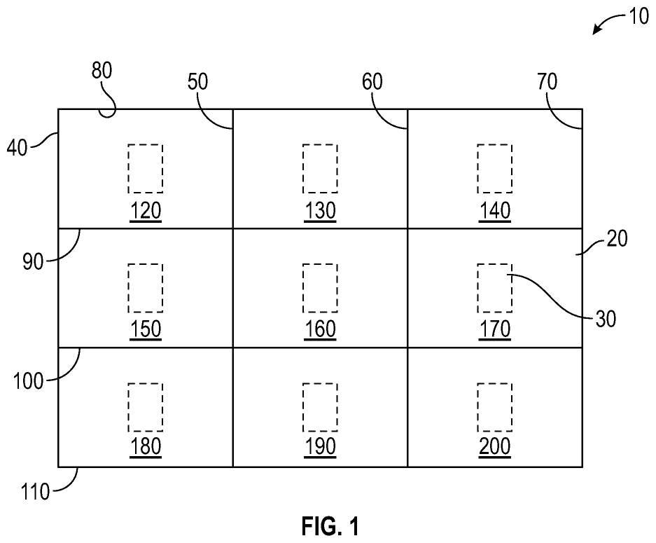

FIG. 1 shows a quilt, in accordance with example embodiments of the disclosure.

Referring to FIG. 1, a quilt 10 may include one or more enclosures 20. The quilt size and arrangement of enclosures can vary depending on a user's oxygen-absorbing needs (e.g., rate of oxygen removal). The rate of oxygen removal using the quilt may be rapid when the quilt is first used, but the rate of oxygen removal may decrease over time. The enclosures 20 may contain oxygen absorbing elements 30 (e.g., oxygen scavengers or pre-activated oxygen scavenger) inside the enclosures 20. The enclosures 20 may be fabricated using two pieces of material sealed together (e.g., sealed together using heat). In some embodiments, each of the two pieces of material may be between 309 millimeters (mm) and 314 mm in width and between 258 mm and 263 mm in length. The two pieces of material may be sealed together (e.g., sealed together using heat) at a first seal 40, a second seal 50, a third seal 60, a fourth seal 70, a fifth seal 80, a sixth seal 90, a seventh seal 100, and an eighth seal 110. In some embodiments, each of the eight seals 40, 50, 60, 70, 80, 90, 100, and 110 may have a width of about three millimeters. Each piece of material may be composed of any suitable material that is a liquid barrier (e.g., resistant to liquid water), permeable to gas (e.g., air), and approved by a medical authority, like the United States Food and Drug Administration (FDA). For example, Tyvek material offered by DuPont may be used. The oxygen absorbing elements 30 can be sealed inside the enclosures 20 between the two pieces of material using a manufacturing method discussed further below.

The enclosures 20 may be organized into a first section 120, a second section 130, a third section 140, a fourth section 150, a fifth section 160, a sixth section 170, a seventh section 180, an eighth section 190 and a ninth section 200. In some embodiments, the quilt 10 may include nine sections and the arrangement of the sections may be similar to a grid. Each of the nine sections may be sealed off from the other sections by the eight seals 40, 50, 60, 70, 80, 90, 100, and 110. In other embodiments, the number of enclosures 20 and the arrangement of the enclosures 20 may vary. For example, the quilt 10 may include one row of four enclosures 20 or two rows with two enclosures in each row. In some embodiment, the number of enclosures 20 and arrangements may be changed in order to adjust the rate of oxygen removal. For example, a larger quilt 10 containing more oxygen absorbing elements may have the capacity to remove more oxygen and may remove oxygen at a higher rate.

Further, each enclosure 20 of the quilt 10 may be substantially rectangular in shape. In some embodiments, the length of each enclosure 20 may be about 78 mm and the width may be about 95 mm. The enclosure 20 may be spaced apart from each other by the width of the seals. In some embodiments, the width of the seals may be about 3 mm. In other embodiments the width and length of the enclosures 20 and the width of the seals may vary.

In some embodiments, the total width of the quilt 10 may range from about 309 mm to about 314 mm and the length of the quilt 10 may range from about 258 mm to about 263 mm. In one embodiment, the width of the quilt 10 may be about 311 mm and the length of the quilt may be about 260 mm. In other embodiments, the length and width of the quilt 10 may vary.

The oxygen absorbing elements 30 used in the quilt 10 may include any suitable oxygen absorbing composition. In some embodiments, the oxygen absorbing elements 30 may include a mixture (e.g., a powder mixture) stored in a package (e.g., sachet). The oxygen absorbing elements 30 may include iron (Fe), carbon (C), diatomaceous earth, salt and water. The composition of the oxygen absorbing elements 30 differs from typical oxygen absorbing compositions (e.g., those that include vermiculite), and can allow for a smaller sachet. In some embodiments, before salt and water is added to the mixture (e.g., powder mixture) for the oxygen absorbing element 30, the mixture may comprise of iron in an amount of about 40-70% by weight of the mixture, diatomaceous earth in an amount of about 10-25% by weight of the mixture, and carbon in an amount of about 10-40% by weight of the mixture. In one embodiment, before salt and water is added to the mixture, the mixture may comprise of iron in an amount of about 56.13% by weight of the mixture, diatomaceous earth in an amount of about 17.6% by weight of the mixture, and carbon in an amount of about 26.27% by weight of the mixture. Various types of carbon may be used in the mixture (e.g., powder mixture). The carbon may be lignite carbon. The carbon may be 325 mesh carbon. Similarly, various types of iron may be used in the mixture. The iron may be sponge iron (e.g., hydrogen-reduced sponge iron and water-atomized iron). In a preferred embodiment, the iron may be 325 mesh iron.

In some embodiments, the amount of salt included in the mixture for the oxygen absorbing elements 30 may be about 0-10% by weight of the mixture (e.g., powder mixture) before salt and water is added. For example, if before salt and water are added to the mixture, the weight of the mixture (which includes iron, diatomaceous earth, and carbon) is about 100 grams, then about 0-10 grams of salt will be added to the mixture. In a preferred embodiment, the amount of salt added may be about 4% by weight of the mixture before salt and water is added. The salt may include sodium chloride (NaCl), potassium chloride (KCl), sodium nitrate (NaNO₃), potassium sulfate (KS₂O₄), potassium perchlorate (KClO₄), or other salts. A salt that does not contain iodine is preferred. The salt may be powdered or granulated.

In some embodiments, the weight of the mixture contained in each of the oxygen absorbing elements 30 may be about 10.2 to 12.4 grams before salt and water are added to the mixture. In one embodiment, the weight of the mixture for one oxygen absorbing element 30 (e.g., one sachet) may be about 11 grams before salt and water are added to the mixture. A single sachet may be able to remove about 1200 cubic centimeters in volume of oxygen over a 24 to 48 hour time period. In some embodiments, the length of the sachet may be about 57 mm to about 63 mm and the width of the sachet may be about 78 mm to about 82 mm.

In some embodiments, the sachets containing the mixture can be manufactured using a packaging machine (e.g., a MC-101 machine offered by Sanko Machinery). The packaging machine may be configured to add the mixture into the sachet and seal the sachet. In some embodiments, the packaging machine may also have a water pump. The water pump may be configured to deposit a precise amount of water into the sachet. In some embodiments, the packaging machine may manufacture the sachets in a nitrogen atmosphere.

In some embodiments, the packaging machine may include a container (e.g., a hopper) positioned over one or more turntables. The mixture (e.g., powder mixture) may be placed in the container and empty sachets can be positioned on the turntables. The container can be configured to deposit a measured amount of the mixture into the sachets positioned on the turntables.

Additionally, water may be added to the mixture (e.g., powder mixture) using the water pump. The water is absorbed by the mixture. The water may be added to the mixture after the mixture is placed into the sachets and before the sachet is sealed. In some embodiments, the amount of water added to the mixture may be about 10-30% by weight of the mixture before salt and water is added. In a preferred embodiment, the amount of water added may be about 23% of the weight of the mixture before salt and water is added. In some embodiments, the water may be deionized (DI) water and/or purified water. A neutral pH (e.g., a pH of about 7) is preferred.

After manufacturing the oxygen absorbing elements 30, the oxygen absorbing elements can be stored in a nitrogen atmosphere (e.g., a cabinet filled with nitrogen gas). The oxygen percentage in the nitrogen atmosphere may be as close to 0% by volume as possible. In some embodiments, the sachets may be stored by vacuum sealing the sachets in a barrier bag using a sealer (e.g., a packaging machine from ULMA).

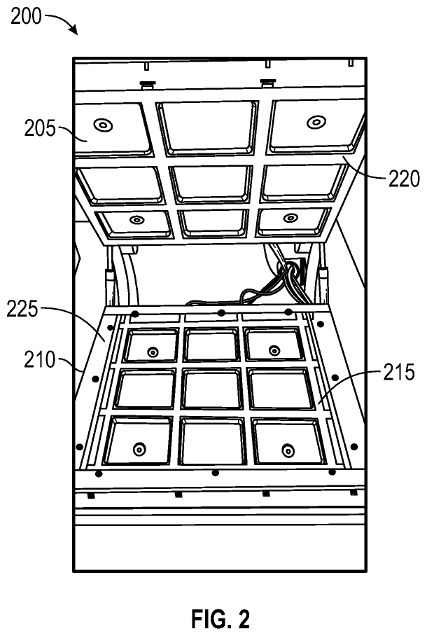

FIG. 2 shows a sealing machine that may be used in the process for fabricating the quilt, in accordance with example embodiments of the disclosure.

According to various embodiments, the quilt 10 may be manufactured using a sealing machine 200 (e.g., PIREG-545 offered by TOSS GmbH). Referring to FIG. 2, the sealing machine 200 may have a sealing part 205 (e.g., a top) and a base 210. The base 210 may have heat elements 215. The heat elements 215 may be arranged in a pattern that corresponds to the eight seals 40, 50, 60, 70, 80, 90, 100, and 110

Referring to FIG. 2, the sealing part 205 may have sealing elements 220. In some embodiments, the sealing elements 220 may be composed of Teflon or other suitable heat resistant material. Additionally, the sealing elements 220 may be arranged in a pattern that corresponds to the eight seals 40, 50, 60, 70, 80, 90, 100, and 110.

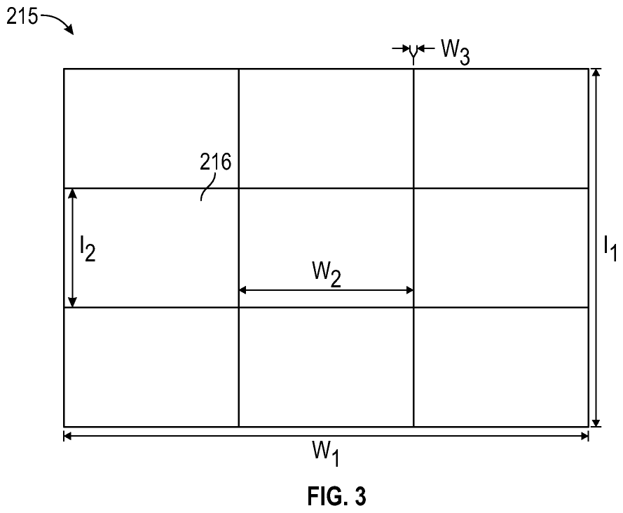

FIG. 3 shows a diagram of a configuration of the heat elements on the base of the sealing machine, in accordance with example embodiments of the disclosure.

Referring to FIG. 3, the heat elements 215 may be arranged in a grid pattern. In one embodiment, the length (l₁) of the grid created by the heat elements 215 may be about 260 mm and the width (w₁) of the grid may be about 311 mm. In one embodiment, each rectangle 216 formed by the grid may have a width (w₂) of about 84 mm and a length (l₂) of about 70 mm. In one embodiment, the width (w₃) of each heat element 215 may be about 8 mm.

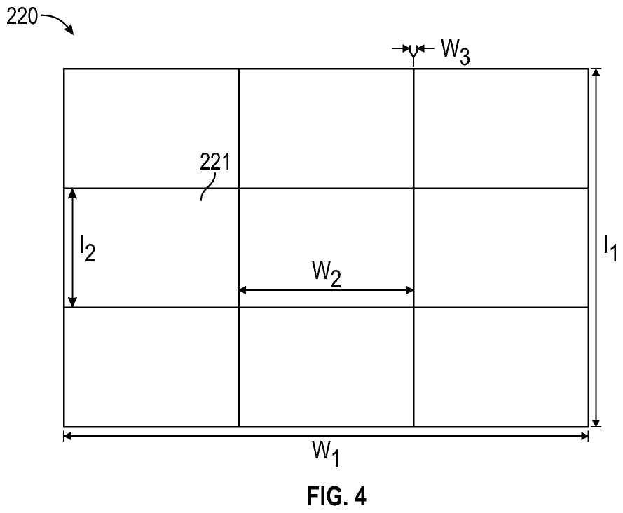

FIG. 4 shows a diagram of a configuration of the sealing elements on the sealing part of the sealing machine, in accordance with example embodiments of the disclosure.

Referring to FIG. 4, the sealing elements 220 may be arranged in a grid pattern. In one embodiment, the length (l₁) of the grid created by the sealing elements 220 may be about 251 mm and the width (w₁) of the grid may be about 302 mm. In one embodiment, each rectangle 221 formed by the grid may have a width (w₂) of about 85 mm and a length (l₂) of about 68 mm. In one embodiment, the width (w₃) of each sealing element 220 may be about 12.7 mm).

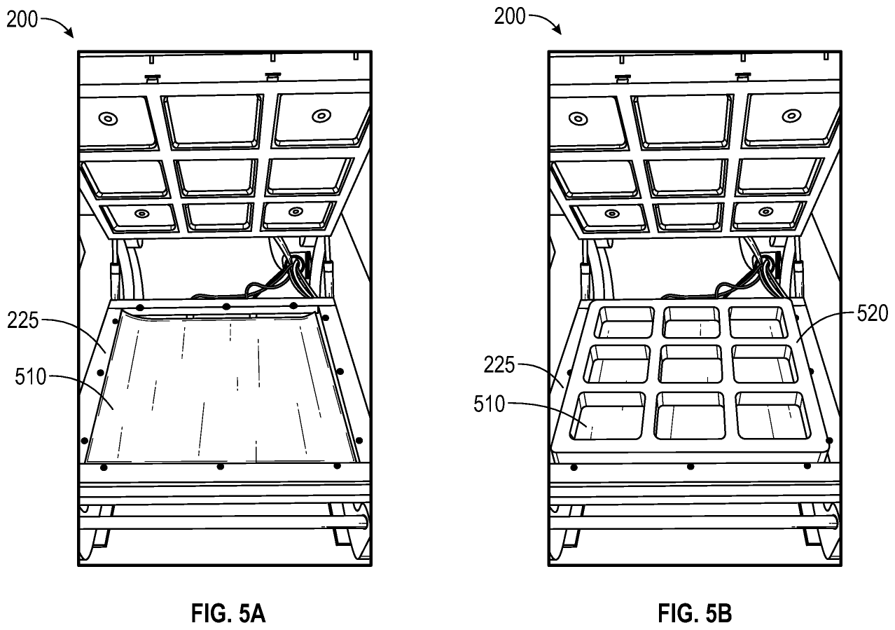

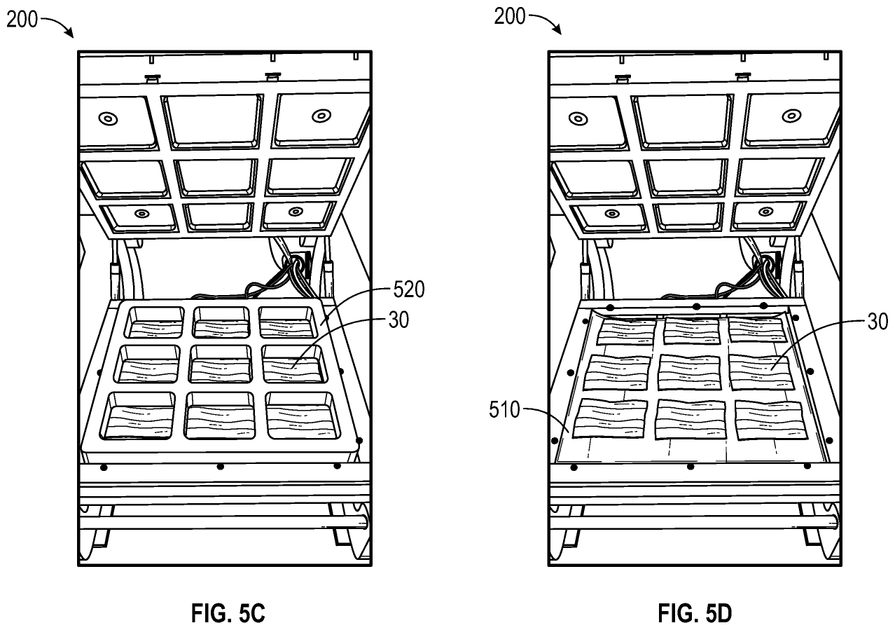

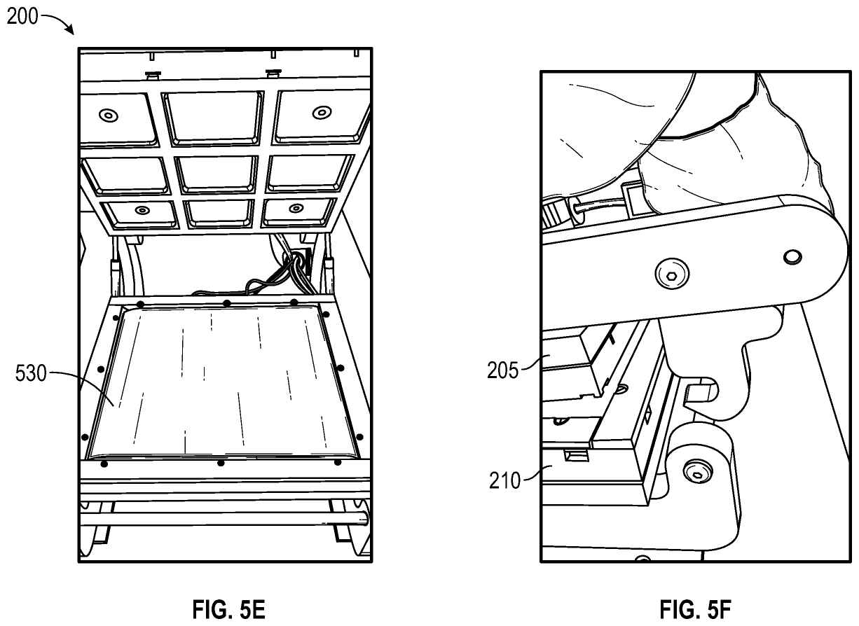

FIGS. 5A-5F shows illustrations of the steps for fabricating the quilt using a sealing machine, in accordance with example embodiments of the disclosure.

FIG. 5A shows a first step in the method for fabricating the quilt 10. Referring to FIG. 5A, a first piece of material 510 used to form the quilt may be placed on heat elements 215 of the base 210 of the sealing machine 200. In some embodiments, the base 210 may include a frame 225 that surrounds the heating elements 215 and the first piece of material 510 is sized to fit within the frame 225. In some embodiments, the heat elements 215 may be preheated. For example, the heat elements 215 may be preheated to about 68 degrees Celsius before the first piece of material 510 is placed on the heat elements 215 of the base 210. The first piece of material 510 may be composed of any suitable material that is resistant to water, permeable to water vapor and gas (e.g., air), and approved by a medical authority, like the FDA. For example, the first piece of material 510 may be Tyvek. The first piece of material 510 may be coated with adhesive (e.g. hot melt adhesive) on the side facing away from the heating elements 215. The first piece of material 510 may be uncoated on the side facing toward the heating elements 215 (e.g., the side that touches the heating elements). In a next step, a positioning guide 520 may be placed on the first piece of material 510 as shown in FIG. 5B. The positioning guide 520 may be positioned to fit within the frame 225. The positioning guide 520 may include one or more compartments arranged in a grid pattern. Each of the compartments of the positioning guide 520 may be substantially rectangular in shape.

Referring to FIG. 5C, oxygen absorbing elements 30 can be positioned on the sheet 510 using the positioning guide 520. In some embodiments, the oxygen absorbing elements 30 may include sachets containing a mixture (e.g., a powder mixture). As previously discussed, the mixture may include iron (Fe), carbon (C), diatomaceous earth, salt, and water. The positioning guide 520 can help ensure that the oxygen absorbing elements 30 are positioned at suitable locations on the first piece of material 510. For example, the oxygen absorbing elements 30 may be placed in each of the compartments of the positioning guide 520.

After placing the oxygen absorbing elements 30 on the first piece of material 510, the positioning guide 520 may be carefully removed so as not to move the oxygen absorbing elements 30. FIG. 5D shows the position of the oxygen absorbing elements 30 on the first piece of material 510 after the positioning guide 520 has been removed.

Referring to FIG. 5E, a second piece of material 530 can be placed over the oxygen absorbing elements 30. Similar to the first piece of material 510, the second piece of material 530 may also be composed of any suitable material that is resistant to water and permeable to water vapor and/or gas (e.g., air). The second piece of material 530 may be approved by a medical authority, like the FDA. For example, the second piece of material 530 may be Tyvek. The second piece of material 530 may be coated with adhesive (e.g. hot melt adhesive) on the side facing toward the oxygen absorbing elements 30 (e.g., the side that touches the oxygen absorbing elements). The second piece of material 530 may be uncoated on the side facing away from the oxygen absorbing elements 30. The second piece of material 530 may be sized to fit within the frame 225. By positioning the second piece of material 530 within the frame, the edges of the second piece of material 530 may align with the edges of the first piece of material 510.

As shown in FIG. 5F, the sealing machine 200 can be closed shut with the sealing part 205 (e.g., the top) on the base 210, and with the first piece of material 510, the second piece of material 530 and the oxygen absorbing elements 30 between the sealing part 205 and the base 210. The heat elements 215 and sealing elements 220 are configured such that, when the sealing part 205 is positioned on the base 210, the sealing elements 220 are positioned on the heat elements 215. After the sealing machine 200 is closed, pressure can be applied by the sealing machine 200 to the first and second pieces of material 510 530 by pressing the heat elements 215 and the sealing elements 220 together, and heat can be applied by the sealing machine 200 to the first and second pieces of material 510 530 by activating the heat elements 215. In some embodiments, the heat elements 215 may be at a temperature of about 232 degrees Celsius when heat is applied to the first and second pieces of material 510 530. In some embodiments, the pressure applied to the first and second pieces of material 510 530 by the sealing machine 200 may not be higher than about 95 pounds per square inch (PSI). Heat and pressure may be applied together to the first and second pieces of material 510 530 for a period of about 1.5 seconds. The quilt 10 may be allowed to cool for a particular amount of time after the sealing time. In some embodiments, the cooling time may be about 1.0 second.

By heating the first and second pieces of material 510 530, the adhesive on the first and second pieces of material 510 530 may be activated and by pressing the first and second pieces of material 510 530 together, the first and second pieces of material 510 530 may be sealed together using the activated adhesive where the heat elements 215 press against the sealing elements 220. By sealing the first and second pieces of material 510 530 together where the heat elements 215 press against the sealing elements 220, the seals 40, 50, 60, 70, 80, 90, 100, 110 are formed and the enclosures 20 are created with the oxygen absorbing elements in each enclosure 20, forming the quilt 10. All eight seals 40, 50, 60, 70, 80, 90, 100, and 110 may be formed simultaneously.

After the quilt 10 is formed, it may be placed in a nitrogen atmosphere (e.g., a nitrogen cabinet). In some embodiments, the nitrogen cabinet may have less than about 2% by volume of oxygen. While in the nitrogen cabinet, the quilt 10 may be placed in a barrier bag with a valve. The barrier bag is impermeable to gas (e.g., oxygen). The barrier bag may include an oxygen indicator dot to indicate when oxygen is present in the bag. The barrier bag may also be visually transparent so the oxygen indicator dot is visible from outside the barrier bag. The oxygen indicator may detect when oxygen is present inside the barrier bag. For example, if the barrier bag is damaged such that there is a hole and oxygen enters the barrier bag, the oxygen indicator will change to a different color. The barrier bag is then sealed using a sealing machine (e.g., a barrier bag sealing machine) in the nitrogen cabinet. In some embodiments, the barrier bag seal may have a width of about 3 mm.

Subsequently, the barrier bag with the quilt 10 can be removed from the nitrogen cabinet. The barrier bag is then sealed a second time outside the nitrogen cabinet. In some embodiments, the second seal may have a width of about 10 mm.

The barrier bag may be used to maintain a low-oxygen environment surrounding the quilt 10 (e.g., during storage and transportation of the quilt 10). The quilt 10 is removed from the barrier bag before use (e.g., when the quilt 10 is used to reduce oxygen in an environment). For example, the quilt 10 may be removed from the barrier bag before it is placed with stored blood used for blood transfusions, where the quilt can be used to reduce the amount of oxygen in the storage environment.

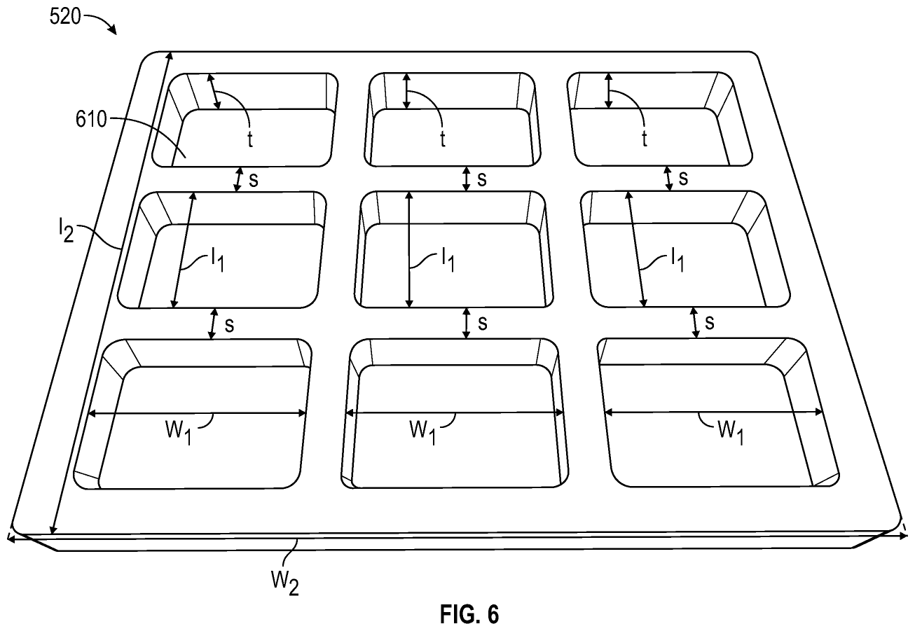

FIG. 6 shows a diagram of a positioning guide that may be used in the process for fabricating the quilt described above, in accordance with example embodiments of the disclosure.

Referring to FIG. 6, the positioning guide 520 may include one or more compartments 610 arranged in a grid pattern. Each compartment 610 of the positioning guide 520 may be substantially rectangular in shape. In some embodiments, the width (w₁) of the compartment 610 may be about 82 mm and the length (I₁) may be about 65 mm. The compartments 610 may be spaced apart from each other. In some embodiments, the space (s) between the compartments 610 may be about 16 mm.

The length (l₂), width (w₂), and thickness (t) of the positioning guide 520 may vary. In some embodiments, the length (l₂) of the positioning guide 520 may be about 261 mm, the width (w₂) of the positioning guide 520 may be about 312 mm, and the thickness (t) of the positioning guide 520 may be about 26 mm.

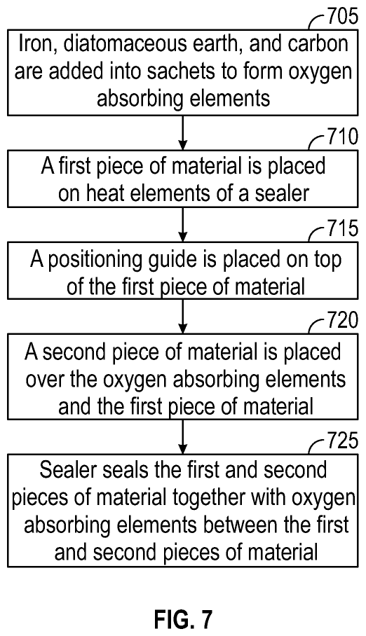

FIG. 7 is a flowchart showing a method for manufacturing the quilt using a sealing machine, in accordance with example embodiments of the disclosure. According to some example embodiments, the number and order of operations illustrated in FIG. 7 may vary. For example, according to some example embodiments, there may be fewer or additional operations, unless otherwise stated or implied to the contrary. Additionally, the order of the operations may vary, unless otherwise stated or implied to the contrary.

Referring to FIG. 7, the method for manufacturing the quilt can begin at 705 by adding iron, diatomaceous earth, and carbon into sachets used for the oxygen absorbing elements. Salt may be added into the sachet. Water may be added to the sachet after iron, diatomaceous earth, and carbon have been added to the sachet. Water may be added to the sachet before the sachet is sealed. In some optional embodiments, at 710, the first piece of material 510 may be placed onto the heat elements 215 on the base 210 of the sealing machine 200. In some embodiments, the heat elements 215 of the sealing machine 200 can be preheated to about 68 degrees Celsius before placing the first sheet of material 510 onto the heat elements 215 of the sealing machine 200. In some optional embodiments, at 715, a positioning guide can be placed on top of the first sheet of material 510. The positioning guide 520 may include one or more compartments 610 arranged in a grid pattern. Each compartment 610 of the positioning guide 520 may be substantially rectangular in shape.

The oxygen absorbing elements 30 can be positioned onto the first piece of material 510 using the positioning guide 520. The oxygen absorbing elements 30 may be taken from storage in the nitrogen cabinet and placed onto the first piece of material 510 without adding additional components to the mixture (e.g., the mixture comprising iron, diatomaceous earth, carbon, salt, and water). For example, the oxygen absorbing elements 30 can be placed into each of the compartments 610 of the positioning guide 520. In some embodiments, the oxygen absorbing elements 30 may include a sachet containing a mixture. As previously discussed, the mixture may include iron (Fe), carbon (C), diatomaceous earth, salt, and water. After placing the oxygen absorbing elements 30 on the sheet 510, the positioning guide 520 can be removed carefully so as not to move the oxygen absorbing elements 30.

In some optional embodiments, at 720, a second piece of material 530 can be placed over the oxygen absorbing elements 530 and the first piece of material 510. The first and second pieces of material 510 530 may be composed of any suitable material that is resistant to water, permeable to gas (e.g., air), and may be approved by a medical authority, like the FDA. For example, the material may be composed of Tyvek. At 725, with the oxygen absorbing elements 30 organized between the first and second pieces of material 510 530, a sealing machine may seal the first and second pieces of material together 510 530. In some embodiments, the first and second pieces of material 510 530 are sealed together at seals 40, 50, 60, 70, 80, 90, 100, and 110 to form the quilt. All eight seals 40, 50, 60, 70, 80, 90, 100, and 110 may be formed simultaneously. In some embodiments, the first and second pieces of material 510 530 are sealed together by the sealing machine 200 at a temperature of about 232 degrees Celsius. In some embodiments, the first and second pieces of material 510 530 are sealed together by the sealing machine 200 at a pressure that is at or below about 95 PSI. In some embodiments, the sealing machine 200 may maintain a temperature of about 232 degrees Celsius and a pressure of about 95 PSI or lower for about 1.5 seconds to create the seals 40, 50, 60, 70, 80, 90, 100, and 110 and first and second pieces of material 510 530 may remain in the sealing machine 200 for about another 1.0 second as the temperature inside the sealing machine 200 decreases and the seals 40, 50, 60, 70, 80, 90, 100, and 110 harden and stabilize.

While this disclosure has been described in detail with particular references to some exemplary embodiments thereof, the exemplary embodiments described herein are not intended to be exhaustive or to limit the scope of the disclosure to the exact forms disclosed. It is understood that the drawings are not necessarily to scale. Persons skilled in the art and technology to which this disclosure pertains will appreciate that alterations and changes in the described structures and methods of assembly and operation can be practiced without meaningfully departing from the principles, spirit, and scope of this disclosure, as set forth in the following claims and their equivalents.

What is claimed is:

1. A method for manufacturing an oxygen absorbing quilt, the method comprising:
placing a first sheet on one or more heat elements, wherein the heat elements are included on a bottom portion of a sealing machine;
placing one or more oxygen absorbing elements on the first sheet;
placing a second sheet over the oxygen absorbing elements and the first sheet, wherein the oxygen absorbing elements are positioned between the first and second sheets;
moving a top portion of the sealing machine to a sealing position to press the first and second sheets against the bottom portion;
increasing, by one or more heat elements, a temperature of the first and second sheets for a sealing time period to form one or more seals between the first and second sheets;
decreasing the temperature of the one or more heat elements; and
waiting for a cooling time period before removing the oxygen absorbing quilt from the sealing machine, wherein the one or more seals stabilize during the cooling time period.

2. The method of claim 1, wherein the first and second sheets are permeable to gas and resistant to liquid.

3. The method of claim 1, wherein adhesive on the first and second sheets form the one or more seals.

4. The method of claim 1, wherein the first and second sheets are about equal in size.

5. The method of claim 1, wherein the one or more oxygen absorbing elements include a mixture of iron, carbon, diatomaceous earth, salt and water.

6. The method of claim 1, wherein the one or more oxygen absorbing elements include one or more packages containing an oxygen-absorbing mixture.

7. The method of claim 1, wherein a positioning guide is used to position the one or more oxygen absorbing elements on the first sheet.

8. The method of claim 1, wherein the one or more seals form one or more enclosures and the one or more oxygen absorbing elements are contained in the one or more enclosures.

9. The method of claim 8, wherein the one or more enclosures are arranged into three rows, wherein each row includes three of the enclosures.

10. An oxygen absorbing element comprising a sealed sachet containing an oxygen absorbing composition, wherein the oxygen absorbing composition comprises iron, carbon, and diatomaceous earth.

11. The oxygen absorbing element of claim 10, wherein the oxygen absorbing element is stored in a nitrogen atmosphere before use.

12. The oxygen absorbing element of claim 10, wherein about 11 grams of the oxygen absorbing composition is capable of removing about 1200 cubic centimeters in volume of oxygen over a time period of about 24 to about 48 hours.

13. The oxygen absorbing element of claim 10, wherein the oxygen absorbing composition further comprises salt and water.

14. The oxygen absorbing element of claim 10, wherein the pH of the water is about 7.

15. The oxygen absorbing element of claim 13, wherein water is about 23% by weight of the mixture before salt and water is added.

16. The oxygen absorbing element of claim 13, wherein salt is about 4% by weight of the mixture before salt and water is added.

17. The oxygen absorbing elements of claim 10, wherein carbon is 325 mesh carbon.

18. The oxygen absorbing elements of claim 10, wherein iron is 325 mesh iron.

19. The oxygen absorbing element of claim 1, wherein the oxygen absorbing composition is comprised of about 40-70 wt % iron, about 10-25 wt % diatomaceous earth, and about 10-40 wt % carbon.

20. The oxygen absorbing elements of claim 10, wherein the oxygen absorbing composition is comprised of about 56.13 wt % iron, about 17.6 wt % diatomaceous earth, and about 26.27 wt % carbon.
